(19) United States
(12) Patent Application Publication
(10) Pub. No.: US 2002/0117863 A1
(43) Pub. Date: Aug. 29, 2002

(54) Vehicle door lock apparatus

(76) Inventor: Masaki Shinkawa, Yamato-shi (JP)

Correspondence Address: PENNIE AND EDMONDS, 1155 AVENUE OF THE AMERICAS, NEW YORK, NY, 100362711

(21) Appl. No.: 10/081,790

(22) Filed: Feb. 22, 2002

(30) Foreign Application Priority Data
Feb. 23, 2001 (JP) 2001-048636

(51) Int. Cl. E05C 3/06

(52) U.S. Cl. 292/216; 292/201

(57) ABSTRACT

A vehicle door lock apparatus to be incorporated into a lock body case and to be secured to a striker of a door on a vehicle, comprises a latch mounted on a first haft and to be secured to the striker, a sector gear mounted on the first shaft, held in a neutral position by a spring, and configured to be rotated by an actuator gear in a forward direction and a reverse direction when a motor is driven, and a lock lever secured to the first shaft, configured to move between a lock position and unlock position of the door, and having a lever section fitted, with a lost motion, in a broad recess made in the sector gear.

### CROSS-REFERENCE TO RELATED APPLICATIONS

This application is based upon and claims the benefit of priority from the prior Japanese Patent Application No. 2001-048636, filed Feb. 23, 2001, the entire contents of which are incorporated herein by reference.

### BACKGROUND OF THE INVENTION

1. Field of the Invention

The present invention relates to a vehicle door lock apparatus that is electrically driven.

2. Description of the Background Art

FIGS. 1 to 3 show a part of a vehicle door lock apparatus that is disclosed in Jpn. Pat. Appln. KOKAI Publication No. 8-326387. As seen from FIGS. 1 to 3, the door lock apparatus has a body 1 made of synthetic resin. The body 1 has a recess 2 in the lower part of its font. In the recess 2, a latch 3 and a ratchet 4 are provided. The latch 3 and the ratchet 4 are mounted on, and can rotate around, shafts 5 and 6, respectively.

A spring (not shown) biases the latch 3 to the clockwise. The latch 3 rotates counterclockwise when it interlocks with the striker 7 fastened to a vehicle as the door of the vehicle, in which the lock apparatus is provided, is closed. As the latch 3 rotates counterclockwise, the ratchet 4 interlocks with the half-latch part of the latch 3, whereby the lock apparatus assumes a half-latch state. The latch can further rotate counterclockwise until the lock apparatus assumes a full-latch state.

FIG. 2 shows an open lever 10, a ratchet lever 12, a lock lever 14, which are provided on the lower part of the back of the body 1. The open lever 10 is coupled with the door handle 11 on the vehicle door and rotatably mounted on the ratchet shaft 6. The ratchet lever 12 is connected to the ratchet 4 by a connecting pin 13. The lock lever 14 is mounted on the latch shaft 5 and can rotate between a lock position and an unlock position. The lock lever 14 is linked to the key cylinder (not shown) or the like provided on the vehicle door.

The door lock apparatus has a lock link 15. The lock link 15 is coupled, at its upper edge, with the lock lever 14. The lock link 15 has a pin 44 that is inserted in the elongated hole 16 made in the open lever 10.

As shown in FIG. 2, the lock lever 14 lies in the unlock position. While the lock lever 14 remains in this position, the pin 44 of the lock link 15 couples the open lever 10 and the ratchet lever 12 together. Thus, the open lever 10 and the ratchet lever 12 can cooperate to release the ratchet 4 from the latch 3 when door handle 11 is rotated to open the vehicle door.

The lock lever 14 may be rotated counterclockwise from the position (FIG. 2) to the lock position. While the lock lever 14 stays in the lock position, the pin 44 of the lock link 15 lies below the elongated hole 16 of the open lever 10. The open lever 10 and the ratchet lever 12 are therefore released from each other. In this condition, the vehicle door cannot be opened, even if the door handle 11 is rotated.

The door lock apparatus further comprises an actuator unit 17 and an actuator receptacle 20. The actuator unit 17 is provided in the receptacle 20. It is designed to switch the lock lever 14 between the lock position and the unlock position. The actuator receptacle 20 comprises a base case 18 and a cover case 19. The base case 18 is formed integral with the upper part of the body 1. The cover case 19 is secured to the base case 18.

FIG. 3 is a schematic representation of the actuator unit 17. The actuator unit 17 comprises an electric motor 21, a gear 22, a gear wheel 23, a small gear 24, a shaft 26, and a sector gear 25. The gear 22 is fixed to the shaft of the electric motor 21. The gear 22 is set in mesh with the gear wheel 23. The small gear 24 is mounted on the gear wheel 23 and coaxial therewith. The small gear 24 is set in mesh with the sector gear 25. The sector gear 25 is mounted on the shaft 26 and can rotate.

A spring (not shown) holds the sector gear 25 at a neutral position. The sector gear 25 rotates clockwise when the motor 21 is driven in forward direction and rotates counterclockwise when the motor 21 is driven in reverse direction.

The changeover lever 27 is fastened to the shaft 26. The lever 27 has a projection 28 at the distal end. The projection 28 lies in the broad recess 29 made in the sector gear 25, with some lost motion.

One end of the shaft 26 passes through the hole 30 made in the cover case 19. An output gear 31 is secured to this end of the shaft 26. The output gear 31 meshes with the gear section 32 of the lock Ax lever 14.

When the gear 22 provided on the shaft of the motor 21 rotates in either direction, the gear wheel 23 is rotated. The small gear 24, which is formed integral with the gear wheel 23, rotates the sector gear 25 from the neutral position for a predetermined angle.

As a result, the projection 28 of the changeover lever 27, which lies in the broad recess 29, may move over the lost motion, abutting on either end of the recess 29. In this case, the output gear 31 secured to the other end of the shaft 26 of the changeover lever 27 is rotated, rotating the output gear 31. The lock lever 14 is therefore rotated, because its gear section 32 is set in mesh with the output gear 31.

Therefore, actuator unit 17 drives the lock lever 14 from the lock position to the unlock position, or vice versa, as the electric motor 21 is driven in the forward direction or the reverse direction. When the power supply to the motor 21 is stopped thereafter, the motor 21 no longer exerts a torque on the sector gear 25. The sector gear 25 returns to the neutral position, by virtue of the spring (not shown).

The actuator unit 17 is configured to transmit the rotation of the motor shaft to the lock lever 14 to change the position of the lock lever 27. To perform this function, the actuator unit 17 needs six parts, i.e., motor 21, gear 22, gear wheel 23, small gear 24, sector gear 25, changeover lever 27, and output gear 31. The unit 17 is complicated in structure.

The output gear 31, which is secured to both the shaft 26 and the changeover lever 27, transmits the rotation of the lever 27 to the lock lever 14. That is, the conventional door lock apparatus is a so-called “two-chamber apparatus,” in which the shaft 26 serves to transmit the motion in the actuator unit 17 to the lock lever 14 that is provided outside the actuator unit 17. The body 1 made of synthetic resin, which contains the actuator unit 17 and the shaft 26, cannot help but be large.

### BRIEF SUMMARY OF THE INVENTION

An object of the present invention is to provide a door lock apparatus for use on vehicles, which is small and simple thanks to reduction in the number of parts used and which can therefore be manufactured at a sufficiently low cost.

A door lock apparatus according to one aspect of the invention comprises a latch mounted on a first haft and to be secured to the striker; a sector gear mounted on the first shaft, held in a neutral position by a spring, and configured to be rotated by an actuator gear in a forward direction and a reverse direction when a motor is driven; and a lock lever secured to the first shaft, configured to move between a lock position and unlock position of the door, and having a lever section fitted, with a lost motion, in a broad recess made in the sector gear. Since the latch, sector gear and lock lever are arranged coaxial to one another, the door lock apparatus is simple in structure and small in size.

Additional objects and advantages of the invention will be set forth in the description that follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded view of a conventional door lock apparatus, showing the body, actuator unit and cover case of the apparatus;

FIG. 2 is a partly sectional view of the apparatus, showing the output components remaining in their neutral positions;

FIG. 3 is a plan view illustrating mainly the actuator unit of the door lock apparatus;

FIG. 4 is a perspective view of the actuator unit incorporate in a vehicle door apparatus according to an embodiment of the present invention;

FIG. 5 is a perspective view of the actuator unit, as seen from the back of the bracket of the unit; and

FIG. 6 is a perspective view of the actuator unit, as seen from the front of the bracket of the unit.

### DETAILED DESCRIPTION OF THE INVENTION

An embodiment of the invention of a vehicle door lock apparatus will be described, with reference to the accompanying drawings.

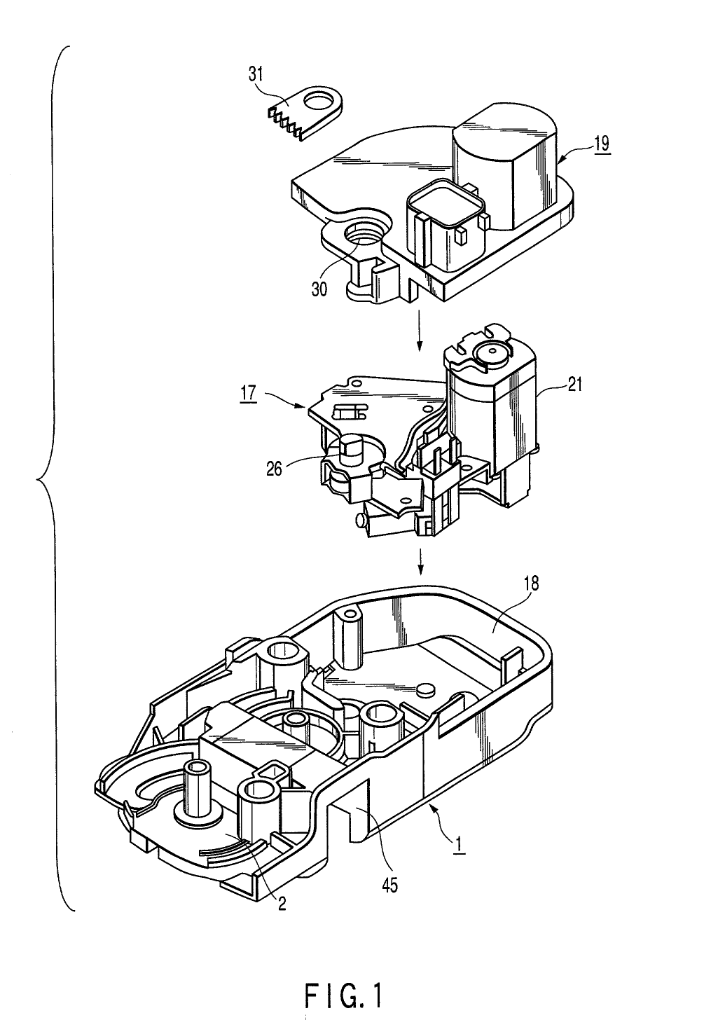

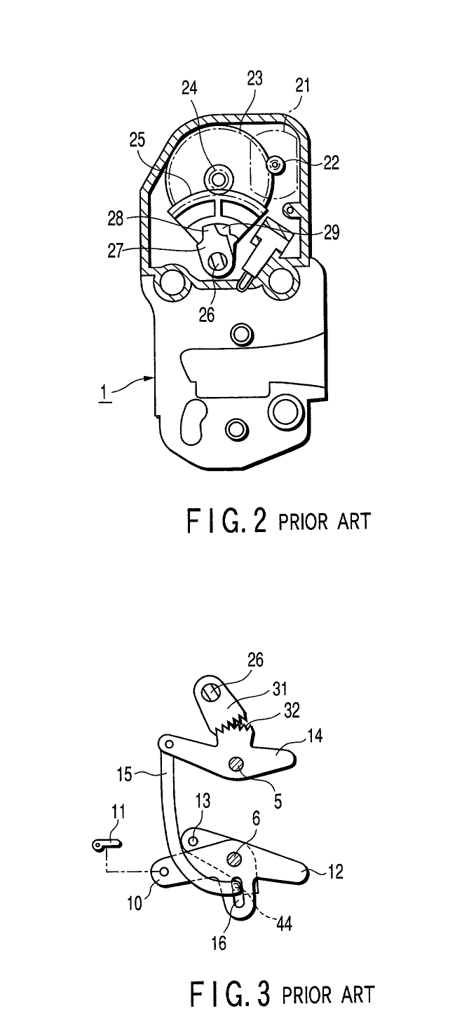

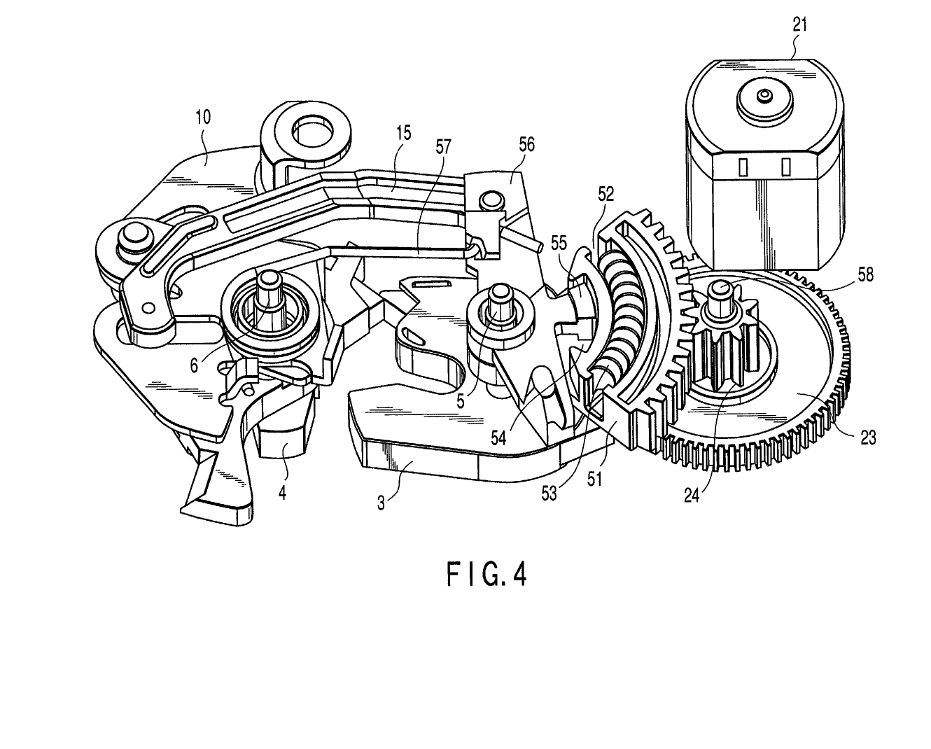

FIG. 4 shows the major components of the actuator unit provided in the body of the vehicle door lock apparatus. The components similar or identical to those shown in FIG. 1 to 3 are designated at the same reference numerals and will not described in detail.

When the gear (not shown) secured on the shaft of the motor 21 is rotated, the gear wheel 23 set in mesh with this gear rotates. The small gear 24 formed integral and coaxial with the gear wheel 23 rotates, too. As the small gear 24 rotates, the sector gear 51 rotates because it meshes with the small gear 24.

The sector gear 51 is similar to the sector gear 25 shown in FIG. 3, but is secured on a latch shaft 5, to which the latch 3 is fastened. The sector gear 51 has an arcuate spring groove 52 cut in a region inner with respect to the outer circumferential surface that has gear teeth. A spring 53 is held in the spring groove 52, biasing the sector gear 25 to its neutral position.

More precisely, the spring 53 lies in the spring groove 52 made in the sector gear 51. The ends of the spring 53 abut on two spring stoppers 62 provided at the tips of brackets 61 (later described) and are held at the ends of the spring groove 51, respectively. Thus, the spring 53 biases the sector gear 51 to the neutral position thereof.

Hence, the spring 53 is compressed between one end of the spring groove 51 and one of the spring stoppers 62 when the electric motor 21 rotates the sector gear 51. When the power supply to the motor 21 is stopped, the spring 53 expands on account of its elasticity, moving the sector gear 51 back to the neutral position.

The sector gear 51 has a board recess 54 in a part inner of the spring groove 52. A lock lever 56 is provided, from which a changeover lever 55 protrudes. The changeover lever 55 is loosely set, with a lost motion, in the broad recess 54 of the sector gear 51.

The lock link 15 couples the lock lever 56 with the open lever 10. The lock lever 56 can therefore be held at the lock position or the unlock position, since it is biased by a spring 57.

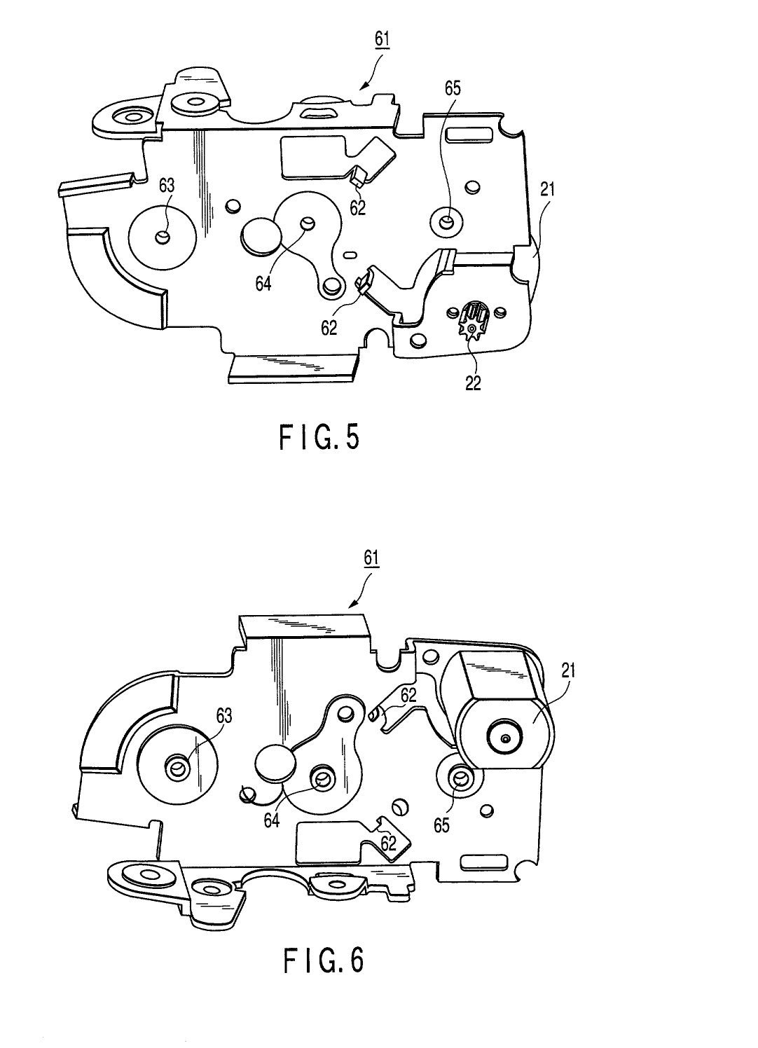

As FIG. 5 shows, the bracket 61 is fitted in and fastened to the body (not shown) of the vehicle door lock apparatus. The bracket 61 has holes 63, 64 and 65. The ratchet shaft 6 and the latch shaft 5 are fitted in the holes 63 and 64, respectively. An actuator shaft 58, on which the small gear 24 is mounted and secured, is fitted in the hole 65.

As described above, the bracket 61 has spring stoppers 62 as is illustrated in FIG. 5. The stoppers 62 control the motion of the spring 53 laid in the spring groove 52 of the sector gear 51. As can be seen from FIG. 6, the bracket 61 directly holds the electric motor 21.

Thus structured, the actuator unit can transmits the rotation of the shaft of the motor 21 to the lock lever 56 to switch the position of the lock lever 56. To transmit the rotation to the lock lever 56, the actuator unit needs only four parts, i.e., gear 22, gear wheel 23, small gear 24 and sector gear 51. This greatly helps to reduce the number of parts of the vehicle door lock apparatus and, ultimately, to simplify the structure of the vehicle door lock apparatus.

In addition, the distance between the latch shaft 5 and the shaft 26 is shorter than in the conventional door lock apparatus. This is because the latch 3, sector gear 51 and lock lever 56 are arranged coaxial with the latch shaft 5. The door lock apparatus of this invention can therefore be smaller than the conventional door lock apparatus.

The vehicle door lock apparatus according to the invention is a single-chamber. All components of the actuator unit, except the motor 21, are arranged in the same space. To be more specific, the gear 22, gear wheel 23, small gear 24, sector gear 51 and lock lever 56 (including the changeover lever 55) are provided in one space. This decreases not only the weight of the apparatus, but also the manufacturing cost of the apparatus.

The stoppers 62 controlling the motion of the spring 53 are formed integral with the bracket 61. The bracket 61 directly holds the electric motor 21. These structural features also serve to simply the structure of the door lock apparatus and the method of manufacturing the apparatus. Needless to say, they contribute to the reduction of the manufacturing cost of the door lock apparatus.

The shape and other features of the components of the door lock apparatus of the invention are not limited to those described above. Further, the connection of the components, the positional relation thereof, and the like can be changed or modified in various ways.

Moreover, the present invention is not limited to the embodiment described above. Rather, various changes and modifications can be made within the scope and spirit of the invention.

The embodiment described above incorporates various aspects of this invention. The components disclosed above may be combined in various ways to provide vehicle door lock apparatuses of different types. For example, only some of the components described above may be used to provide a vehicle door lock apparatus that achieves the object specified in “BRIEF SUMMARY OF THE INVENTION.” Such a door lock apparatus can fall within the scope of the present invention.

A vehicle door lock apparatus according to one aspect of the invention comprises: a latch mounted on a first haft and to be secured to the striker; a sector gear mounted on the first shaft, held in a neutral position by a spring, and configured to be rotated by an actuator gear in a forward direction and a reverse direction when a motor is driven; and a lock lever secured to the first shaft, configured to move between a lock position and unlock position of the door, and having a lever section fitted, with a lost motion, in a broad recess made in the sector gear. The latch, sector gear and lock lever are mounted on the same shaft, whereas they are mounted on different shafts in the conventional door lock apparatus for used in a vehicle door. Thus, the apparatus has a simpler structure and can be smaller.

The vehicle door lock apparatus of the invention may be modified in such various manners as will be described below. Each modification is simple in structure, can be manufactured in fewer steps and, ultimately, at a lower cost. The modifications described below may be reduced to practice, either singly or in combination.

(1) A bracket which holds the first shaft and a second shaft of the actuator gear is further provided. Having a simple structure, this apparatus can be manufactured in fewer steps and at a lower cost.

(2) A bracket having a hole to fix the first shaft is further provided.

(3) The bracket has spring stoppers which controls motion of the spring which holds the sector gear in the neutral position. Simple in structure, the apparatus can be manufactured in fewer steps and at a lower cost, too.

(4) The motor is fastened to the bracket. Having a simple structure, this apparatus can be manufactured in fewer steps and at a lower cost, too.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A vehicle door lock apparatus to be incorporated into a lock body case and to be secured to a striker of a door on a vehicle, comprising:
a latch mounted on a first haft and to be secured to the striker;
a sector gear mounted on the first shaft, held in a neutral position by a spring, and configured to be rotated by an actuator gear in a forward direction and a reverse direction when a motor is driven; and
a lock lever secured to the first shaft, configured to move between a lock position and unlock position of the door, and having a lever section fitted, with a lost motion, in a broad recess made in the sector gear.

2. An apparatus according to claim 1, further comprising a bracket which holds the first shaft and a second shaft of the actuator gear.

3. An apparatus according to claim 1, further comprising a bracket having a hole to fix the first shaft.

4. An apparatus according to claim 3, wherein the bracket has spring stoppers which controls motion of the spring which holds the sector gear in the neutral position.

5. An apparatus according to claim 3, wherein the motor is fastened to the bracket.
